(19) United States
(12) Patent Application Publication
(10) Pub. No.: US 2011/0111730 A1
(43) Pub. Date: May 12, 2011

(54) Method of Setting Up a Communication Channel

(76) Inventor: Dean N. McEvoy, Preston Lancashire (GB)

(21) Appl. No.: 12/989,820

(22) PCT Filed: Apr. 29, 2009
(86) PCT No.: PCT/GB2009/050439

§ 371 Date: Jan. 28, 2011

(30) Foreign Application Priority Data
Apr. 30, 2008 (GB) 0807845.3

(51) Int. Cl. H04W 40/00; H04W 4/26

(52) U.S. Cl. 455/408; 455/422.1

(57) ABSTRACT

Disclosed is a method of setting up a communication channel, between a wireless device (10) and another party (50), via a wireless infrastructure network (20) and a control network (30), the method comprising the steps of: the wireless device initiating contact with the control network via the wireless infrastructure network; the control network, in response to the initiation of contact, setting up a communication channel with the mobile device via the wireless infrastructure network.

The present invention is related to a system, apparatus and method for communicating from a mobile wireless device to a wireless network whereby a substantial proportion of the “intelligence” resides in the network rather than in the mobile device itself.

Typically, in a wireless communication network e.g. a cellular telephone network, a user of the network owns or rents a handset device for communication with the fixed infrastructure part of the wireless network, with the handset device being able to dial another telephone by use of a numeric keypad. Such an arrangement requires a mobile device provided with a keypad for entering data, a display for displaying signals and messages from the network and a significant amount of processing power in order to interact with the network.

Such an arrangement, although commonplace, has several disadvantages. In particular, if a user of the mobile device loses said device, or it is damaged in some way, the user generally loses a great deal of personal information including telephone numbers, addresses and other contact details from the telephone's address book.

Very few users tend, in practice, to backup the contents of their address book, and recreating such data can be problematic. Furthermore, there is the direct financial cost of losing a handset which can cost several hundred pounds to replace.

An aim of embodiments of the present invention is to address these and other shortcomings in prior art telecommunication systems whether mentioned herein or not. A further aim of embodiments of the invention is to control costs by offering users greater flexibility in selection of call tariffs.

According to an aspect of the present invention there is provided a method of setting up a communication channel, between a wireless device and another party, via a wireless infrastructure network and a control network, the method comprising the steps of: the wireless device initiating contact with the control network via the wireless infrastructure network; the control network, in response to the initiation of contact, setting up a communication channel with the mobile device via the wireless infrastructure network.

According to another aspect of the invention, there is provided an apparatus arranged for wireless communication with a control network via a wireless infrastructure, wherein the apparatus is arranged to initiate communications with the control network to indicate that a user of the apparatus wishes to communicate with another party, and wherein the apparatus is further arranged to await the receipt of an incoming message from the network in response to the initial communication such that the communication with the other party occurs with the wireless device as a recipient rather than initiator of the communication.

Preferably, the initial contact from the mobile device is either a standard telephone call or a data ping.

If the initial contact is a standard telephone call, the control network is arranged to terminate the telephone call rather than answer it. In this way, the control network is aware that the mobile user is attempting to contact the network and can use the CLI to set up a communication channel in return, thereby making the seeming initiator of the call the actual recipient.

Preferably, once the call is terminated or the data ping has been sent, the mobile device is arranged to play a ring tone in so the user is unaware that the original call has been terminated and a new call is being set up in reverse.

Preferably, once the control network has established a communication channel with the mobile device, the ring tone is terminated and voice communication can commence exactly as though the control network were the recipient, rather than the initiator of the call.

Preferably, the control network uses a speech engine to interpret voice commands from the user of the mobile device.

Preferably, the voice commands from the user are cross-checked by the speech engine against one or more pre-stored voice tags stored in the speech engine.

Preferably, once the intended recipient of the call from the mobile user is determined, the control network places a call to that party, connects the mobile caller to that party and then drops out of the call, whilst still monitoring the call duration for billing purposes.

Other preferred aspects of the invention will be apparent from the following description.

For a better understanding of the invention, and to show how embodiments of the same may be carried into effect, reference will now be made, by way of example, to the accompanying diagrammatic drawings in which:

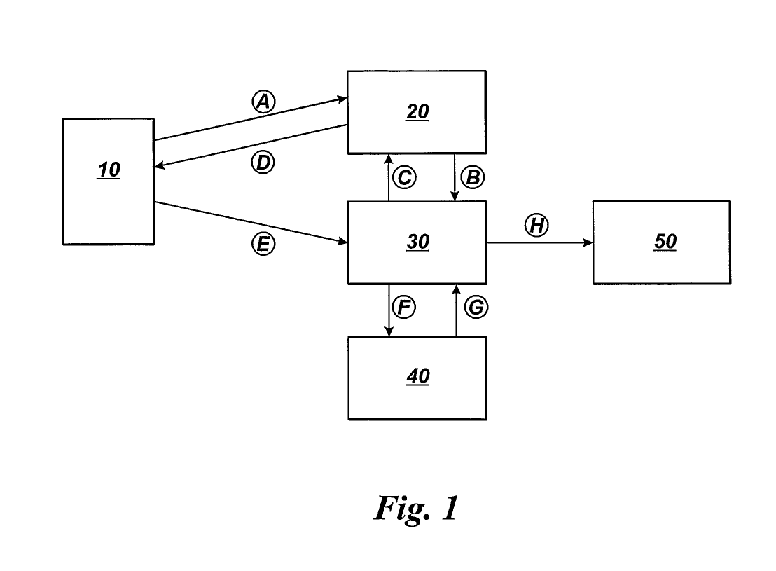

FIG. 1 shows a schematic overview of a first embodiment of the present invention.

The first embodiment of the present invention utilises a portable device for contacting the fixed parts of a wireless network, specifically a cellular telephone network. An embodiment of the present invention comprises a mobile device which is, in many respects, similar to a prior art mobile telephone, except that it lacks both a multi-key keypad for entering numbers and a display for displaying information to the user. The omission of these parts enables the device to be manufactured to a much smaller form-factor, meaning that the entire device can be configured to be ‘worn’ behind the ear of the user, in the style of prior art hearing aids or Bluetooth® hands-free headsets. Unlike a Bluetooth headset, however, the entire device is arranged to fit to a user's ear and does not need any other equipment to be carried by a user.

Since the mobile device lacks a keypad and a display, all inputs from the user are achieved via a much-reduced user-interface. In a preferred embodiment, only one or two user-operable keys are provided and use is made of voice commands. All outputs to the user are via synthesised speech. Other embodiments of the invention though, may be provided with more keys up to or exceeding the number found on a prior art telephone having a full numeric keypad.

An alternative embodiment of the invention comprises an additional clip-on keypad and, optionally, a display part, so that a more conventional user-interface is provided.

This does not detract from certain key features of the device and permits additional functionality to be provided to the user.

Since, in a preferred embodiment, the mobile device is intended to be as basic as possible and to perform as little processing as necessary, the bulk of the processing is performed at the fixed part network the network. The fixed part of the network comprises two separate entities which may be operated by a single party or two parties.

The first part of the fixed network is hereafter termed the wireless infrastructure and includes the base stations and switching apparatus. The wireless infrastructure is known from the prior art and may constitute a typical cellular network as operated by a network provider such as Vodafone or Orange.

The second part of the fixed network is responsible for interfacing embodiments of the present invention to the first part—the wireless infrastructure, including maintaining databases related to the registered users of embodiments of the invention, including pre-stored contact details. The second part is hereafter termed the control network.

In order to make use of the system, a user must first register his/her details with the control network via the wireless infrastructure. This can be done, typically, by use of a website or via a telephone call. If done via a website, the user is asked to provide a voice sample, saying their name and possible one or more identifying words, selected by the system or the user. The system stores these voice samples, which are then used in future transactions to identify the user.

The user can also, via the web interface to the control network, register one or more selected contacts to be stored specifically within that user's account for future call purposes. This will be described in more detail shortly.

Once the user has registered with the control network, he is able to access the system from his mobile device. The mobile devices are intended to be sold at a very reasonable price (compared to fully-featured mobile devices) from a variety of retailers and, since they are not specifically tied to a particular user, any such device can be used by any registered user to access his account with the control network and so make and receive calls.

The mobile device 10 is pre-programmed, with a telephone number, or possibly a plurality of numbers, any of which may be a short-code, to access the system. The pre-programming of the number or numbers is generally performed at a configuration stage, when, or shortly after the device first communicates with the control network.

In order to make a call, the user needs to initiate a call to the system. This is done by activating the user-operable key (or one of the keys) which is provided on the device. By doing so, the device acts according to a pre-programmed instruction to call the pre-stored number. This is shown as Step A in FIG. 1.

The request to access the wireless infrastructure 20 is routed in the normal way to the control network 30 (step B), where the call is received. Upon accessing the control network 30 and the incoming call being detected, the control network immediately terminates the call without answering it. The control network 30 then immediately calls the mobile device 10 back on it's number, which it discerned from the incoming CLI (caller-line identification). The callback to the mobile device is performed via the wireless infrastructure 20 (Steps C and D).

Alternatively, the control network may be alerted that a mobile device 10 wishes to make a call by means of a data ‘ping’, by momentarily accessing a pre-defined IP address. The pre-defined IP address is associated with the control network which then knows that mobile device, and which mobile device, wishes to make a call and continues as set out before.

It does not matter which technique is used, as long as the system is made aware that a particular mobile device is seeking access, and other techniques may be employed to access the control network 30 from a mobile device 10, via the wireless infrastructure 20.

Since the mobile device 10 is pre-programmed to dial only a single number, or one of a plurality of numbers, it may conveniently be fitted with a SIM (Subscriber Identity Module) from any suitable wireless network (e.g. Orange, Vodafone etc). In this way, the user is able to acquire airtime via the SIM, which may be of a Pay as You Go (PAYG) type, which may never run out of credit (depending on the tariff scheme in operation), since all call charging is managed by the system and call charges are not deducted from any credit on the card.

This can be achieved, since the mobile device is arranged to never make a call which is answered, and so no credit associated with the SIM card is ever used up on call charges. Some network operators deduct credit just for keeping the phone number active.

As mentioned, the mobile device 10 simply calls the system (Steps A, B), which detects the incoming call, terminates it and then calls the mobile device back (Steps C, D), meaning that the mobile device is effectively only used to receive active calls and never to make them. Following the key on the mobile device being pressed to access the control network, the user is presented with a dialling tone, which may be pre-stored as a sound sample in the mobile device 10. When the system successfully calls the mobile device back, the ringing tone is terminated, and the user is challenged by the system to identify himself by a spoken request. Alternatively, depending on the security setting, the voice identification step may be omitted.

To identify himself, the user simply states his name and the control network, using speech recognition software, checks the identity of the user and so compares the voice to ensure that the user is indeed who he claims to be.

Once authenticated, the user can initiate a call to one of his pre-stored numbers by simply mentioning the name of the contact e.g. “call James”. This is shown as step E, but note that the actual communication is via the wireless infrastructure as before, but is shown as direct with the control network 30 for simplicity.

This prompts the control network 30 to interrogate speech engine 40 for a sound sample corresponding to the voice prompt given by the user—Step F.

If more than one such name is stored, the system may prompt for clarification. If only a single match is found, then that contact number is passed from the speech engine 40 to the control network 30—Step G.

The Control network 30 then places a call to the intended recipient 50 via a suitable network—Step H, which may be a fixed-line or wireless network as appropriate.

Note that in an alternative embodiment, comprising the previously mentioned clip-on keypad, or other way of entering number data, the speech engine is bypassed and the mobile device sends pre-stored or generated DTMF tones to indicate the number to be dialled.

Note that the control network 30 is the system entity which actually dials the call-recipient 50 and not the user of the mobile device 10. In this way, as described, the mobile device is actually receiving a call, and so incurs no direct costs for initiating a call, even though it was the user of the mobile device 10 who initiated the call setup process.

Even though the user of the mobile device incurs no call charges for use of the wireless infrastructure, since he is only receiving, rather than making a call via that route, he will be charged by the operator of the control network, which logs all calls made on behalf of each user and can bill accordingly.

If the mobile device used to contact the control network has been used before, and is so known to the system, then the initial security step of asking the user for authentication may be omitted, and the user may be asked instead what action he would like to perform. Since the command given by the user is subjected to analysis by the control network, there is still a degree of security provided, since if an unauthorised user attempts to initiate a call, the voice-recognition system 40 will detect that the caller is not the registered user and refuse to proceed.

However, by allowing a user to call from any phone, by means of a readily available contact number, and identify themselves to the control network, a user can always be connected to any of their contacts, which are pre-stored in the control network, and need never worry about losing the contact or personal data stored in their phone again, since all such information is stored securely on a remote system, which they can access in a straightforward manner.

Indeed, if the user needs to gain access to his contacts but does not have ready access to his mobile device or a similar one (each having the pre-programmed access number), he can simply dial a number, which he may know or can learn from the control network's website, in order to gain access to the system. From that point on, the call initiation and set up process continues exactly as before.

To receive a call, the mobile device can be configured to receive calls only from the control network, ensuring that the device cannot be called directly (which it be, as it does have its own number), thereby routing all calls through the network.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of setting up a communication channel, between a wireless device and another party, via a wireless infrastructure network and a control network, the method comprising the steps of: the wireless device initiating contact with the control network via the wireless infrastructure network; the control network, in response to the initiation of contact, setting up a communication channel with the mobile device via the wireless infrastructure network.

2. The method as claimed in claim 1 wherein the initial contact from the wireless device is either a standard telephone call or a data ping.

3. The method as claimed in claim 2 wherein if the initial contact is a telephone call, the control network is arranged to terminate the telephone call rather than answer it, and then set up a communication channel in return, thereby making the wireless device the recipient rather than initiator of the call.

4. The method as claimed in claim 2 wherein once the call is terminated or the data ping has been sent, the wireless device is arranged to play a ring tone so the user is unaware that the original call has been terminated and a new call is being set up.

5. The method as claimed in claim 4 wherein once the control network has established a communication channel with the wireless device, the ring tone is terminated and voice communication can commence.

6. The method as claimed in claim 1 wherein the control network uses a speech engine to interpret voice commands from the user of the wireless device.

7. The method as claimed in claim 6 wherein the voice commands from the user are cross-checked by the speech engine against one or more pre-stored voice tags stored in the speech engine.

8. The method as claimed in claim 1 wherein once the intended recipient of the call from the wireless device is determined, the control network places a call to that party, connects the wireless device to that party and then drops out of the call, whilst still monitoring the call duration for billing purposes.

9. An apparatus arranged for wireless communication with a control network via a wireless infrastructure, wherein the apparatus is arranged to initiate communications with the control network to indicate that a user of the apparatus wishes to communicate with another party, and wherein the apparatus is further arranged to await the receipt of an incoming message from the network in response to the initial communication such that the communication with the other party occurs with the wireless device as a recipient rather than initiator of the communication.

10. The apparatus of claim 9 wherein the initial communication from the apparatus to the control network is in the form of a telephone call or a data ping.

11. The apparatus of claim 9 comprising a ringer to play a ring tone so the user is unaware that the original call has been terminated and a new call is being set up.
